(19) United States
(12) Patent Application Publication
(10) Pub. No.: US 2013/0124370 A1
(43) Pub. Date: May 16, 2013

(54) Workflow integration and presentation management

(71) Applicant: Kenneth B. Moore, Seattle, WA (US)

(72) Inventor: Kenneth B. Moore, Seattle, WA (US)

(21) Appl. No.: 11/703,366

(22) Filed: Feb. 7, 2007

(51) Int. Cl. G06Q 30/06

(52) U.S. Cl. CPC G06Q 30/0641
USPC 705/27.1

(57) ABSTRACT

A content editor application enables a computer user to modify content displayed on a display screen. In response to receiving a command from the computer user to view different selectable font styles for application to selected content on the display screen, the content editor application initiates display of a listing of different selectable font types including active fonts, inactive fonts, and/or on-line available (e.g., purchasable) fonts. The active fonts in the listing are those registered with a corresponding operating system while inactive fonts presented in the listing are those not currently registered with the operating system. Based on selection of an entry (e.g., a particular font type) in the listing, the content editor application applies a respective selected presentation option (e.g., selected font type) to modify the content on the display screen. The computer user can initiate commands to activate fonts, deactivate fonts, and/or obtain fonts on-line.

### BACKGROUND

Use of editors has become quite common in conventional computer applications. One reason for such a broad acceptance of text editors is the convenience afforded by their use.

For example, via use of a window-based application such as a text editor, a computer user can open a “window” on a computer screen and modify the contents of a file such as a text-based document. Typically, text editor applications enable a user to select text in a document and thereafter apply text editing or formatting commands such as bolding, italicizing, underlining, copying, pasting, formatting, etc.

One type of editing function is font selection. In the context of most editor applications, font selection typically involves selection of a font type (from a pull-down menu) for application to a text string. Based on selection from a menu of different font options, a respective computer user is able to easily change a corresponding font style according to his/her preference.

Management of fonts typically requires use of a font manager application to activate and deactivate fonts with a corresponding operating system. Registering fonts with an operating system “activates” a font so that the font can be “seen” by any editor applications being launched by the operating system.

Keeping too many fonts (e.g., thousands of fonts) activated at the same time can slow down a computer and potentially cause font corruption. Accordingly, a font manager program can be used to limit the number of fonts activated at any given time.

### SUMMARY

Conventional techniques enable management of fonts using a third party font management software tool as discussed above. Use of such a tool (e.g., a third-party font management tool running separate from other applications) enables a designer to identify and control which fonts are registered with the operating system as being active versus inactive. Careful management can prevent too many fonts from being activated at the same time. However, if a designer decides or wishes to use an inactive font for content being modified in a respective design session, the designer typically must launch the third party font management tool to activate a respective font the designer would like to use in the current design and thereafter revert back to use of the original content editor application for manual selection and application of the newly activated font to the content being modified. Use of the font management application therefore can interrupt the designer's workflow.

Techniques discussed herein deviate with respect to conventional applications such as those discussed above as well as other techniques known in the prior art. For example, certain specific embodiments herein are directed to overcoming deficiencies associated with the above-mentioned techniques and/or other deficiencies in the prior art not mentioned above.

In a general embodiment, a content editor application enables modification of content displayed on a display screen. In response to receiving a command to view different selectable presentation options (e.g., font styles) for modifying content being edited on the display screen, the content editor application initiates display of a listing of the different selectable presentation options (e.g., different font types) including active presentation options and inactive presentation options. The listing can be presented for viewing in a dialog box. In one embodiment, the active presentation options in the listing represent fonts that are registered with a corresponding operating system while inactive presentation options in the listing are fonts not currently registered with the operating system. Based on selection of an entry (e.g., a particular font type) in the listing, the content editor application applies a respective selected presentation option (e.g., selected font type) to modify the content on the display screen.

Embodiments herein contrast with conventional applications. For example, the listing produced by the content editor application and displayed on the display screen enables selection and application of both active and inactive types of fonts (e.g., presentation options) for modifying selected content. This eliminates the need for the computer user to leave a current editor application, launch and operate a third party management tool to activate a selected presentation option, and return to the current editor application and manually apply the selected font to the content being modified.

Further embodiments herein enable a respective computer user to select a currently inactive font from the listing for application to content being edited. Upon selection of an inactive entry in the listing, the content editor application can initiate functions such as modification of the content according to a selected inactive presentation option. Selection and application of an inactive font can propmpt application of the font to content as well as automatic registration of the selected inactive presentation option with an operating system to activate the selected inactive presentation option. Accordingly, an inactive presentation option can be activated (e.g., registered with the operating system) in the context of a content editor application for later use or use by or other content editor applications launched by the operating system.

One embodiment herein includes a content editor application that provides a visual indication in the (font) listing on the display screen in order to enable the computer user to distinguish between active and inactive presentation options displayed in the listing. For example, the listing can indicate which presentation options (e.g., selectable font styles) are currently inactive as not being registered with a corresponding operating system. Note that the listing supported by the content editor application can provide other types of status information such as whether a respective presentation option (e.g., font style) can be purchased and downloaded via an on-line (e.g., Internet) transaction.

In addition to displaying the different presentation options and their respective statuses, the listing can enable a corresponding computer user to change a status associated with each of the different presentation options in the listing. For example, the content editor application according to embodiments herein can enable the computer user to provide input with respect to entries in the listing to selectively register (e.g., activate) inactive fonts and selectively de-register (e.g., inactivate) currently active fonts. Accordingly, the computer user can initiate management of different presentation style options (e.g., fonts) via functions provided by the content editor application as opposed to a separate font management application running on the operating system.

As briefly mentioned above, in addition to enabling activation and deactivation of fonts, the content editor application can enable additional functions such as purchase and/or downloading of available presentation options from a remote server on the Internet. For example, in response to receiving a command, the content editor application according to embodiments herein can initiate display of a listing of the different selectable options including presentation style options that are available for purchase online from a server located at a remote location over a network. For each of the presentation style options (e.g., fonts) in the listing, the content editor application can provide a sample viewing in the listing of how the content on the display screen would appear if a corresponding selectable presentation style option in the listing were applied to the content on the display screen. Thus, a computer user can view how a corresponding font will appear in a composition (e.g., a document) prior to actual purchase and application to the content being modified. If desired, the computer user can initiate purchase and downloading of the font using the content editor application.

Accordingly, a respective computer user can easily access and therefore manage fonts via novel functionality provided by a corresponding content editor application.

Note that embodiments herein can include a content editor application and/or computer system configured to carry out and/or support any or all of the method operations disclosed herein. In other words, one or more computerized devices, processors, and/or software applications can be programmed and/or configured to operate as explained herein to carry out different embodiments of the invention.

Yet other embodiments herein include software programs to perform the steps and operations summarized above and disclosed in detail below. One such embodiment comprises a computer program product that has a computer-readable medium including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present disclosure is directed to a computer program product that includes a computer readable medium having instructions stored thereon for supporting operations such as enabling editing functions and/or activation and deactivation of different presentation options (e.g., fonts). The instructions, when carried out by a processor of a respective computer device, cause the processor to: i) receive a command to view different selectable presentation options for modifying a respective presentation style associated with content being edited on a display screen; ii) in response to receiving the command, initiate display of a listing of the different selectable presentation options including activated presentation options (e.g., registered fonts) and inactivated presentation options (e.g., unregistered fonts); and iii) based on selection of an entry in the listing, apply a respective selected presentation option to modify the content on the display screen. The numbering of the steps has been added for clarity sake; these steps may not need to be in the particular order as discussed above.

Other embodiments of the present disclosure include software programs to perform any of the method embodiment steps and operations summarized above and disclosed in detail below.

Also, it is to be understood that the system, method, apparatus, etc. herein can be embodied strictly as a software program, as a hybrid of software and hardware, or as hardware alone such as within a processor, or within an operating system or a within a software application. Although not necessary, example embodiments of the invention may be implemented within products and/or software applications such as those manufactured by Adobe Systems, Inc. of San Jose, Calif., USA.

As discussed above, techniques herein are well suited for use in management of fonts and different workflow applications. However, it should be noted that embodiments herein are not limited to use in such applications and that the techniques discussed herein are well suited for use in other applications as well.

Note that each of the different features, techniques, configurations, etc. discussed herein can be implemented independently or in combination with each other. Accordingly, the present invention can be embodied and viewed in many different ways.

Also note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles and concepts.

FIG. 1 is a diagram of a computer environment illustrating use of a content editor application according to embodiments herein.

FIG. 2 is an example of a computer environment and corresponding computer system for executing a content editor application and related functions according to embodiments herein.

FIG. 3 is a flowchart illustrating a technique for displaying different types of presentation options in a content editor application according to embodiments herein.

FIGS. 4 and 5 combine to form a flowchart illustrating different types of functionality provided by a content editor application according to embodiments herein.

FIG. 6 is a flowchart illustrating a technique for enabling activation and deactivation of different font styles according to embodiments herein.

FIG. 7 is a flowchart illustrating different functionality such as on-line font selection associated with a content editor application according to embodiments herein.

FIGS. 8-11 are screenshots illustrating different functionality provided by a content editor application according to embodiments herein.

### DETAILED DESCRIPTION

According to an example embodiment, a content editor application provides different types of functionality to a respective user. For example, a content editor application enables management of presentation options (e.g., fonts) such as activation and deactivation of fonts, previewing and selection of font options available on-line, display of different font options in a dialog box, etc. As will be discussed, functionality provided by the content editor application provides flexibility and enables more efficient font management of modification functions and corresponding application of the font styles.

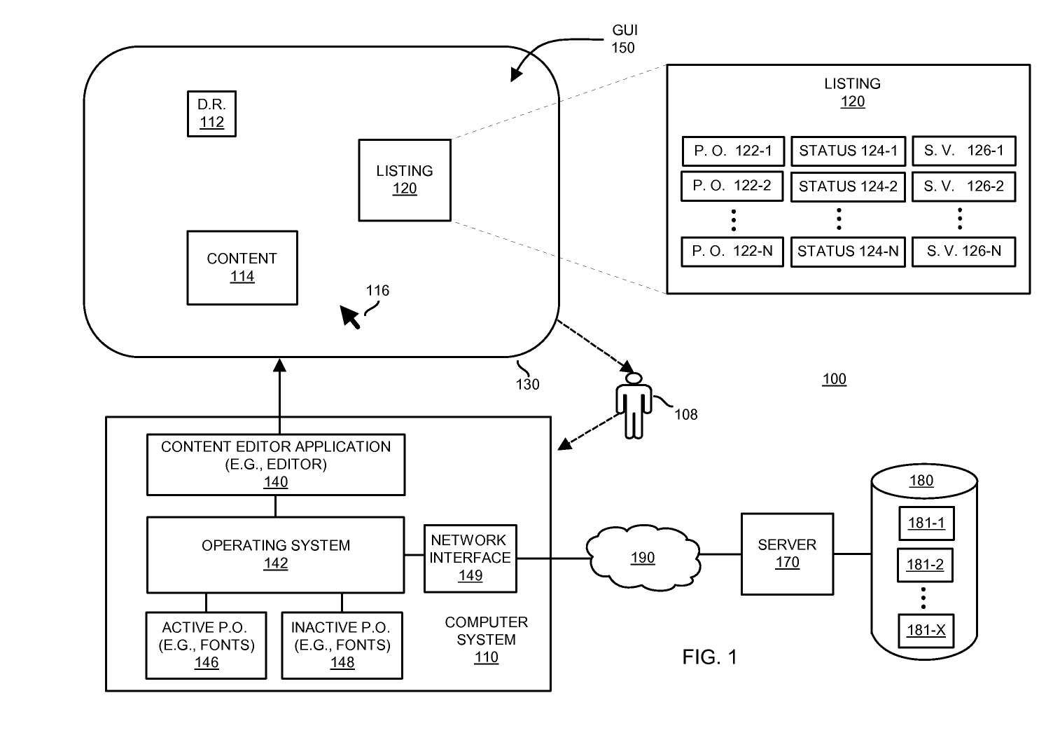

FIG. 1 is a diagram of a computer environment 100 supporting execution of and functionality associated with content editor application 140 according to an embodiment herein. As shown, computer environment 100 includes computer system 110, display screen 130, network 190, server 170, and repository 180. Computer system 110 includes content editor application 140, operating system 142, active presentation options 146 (e.g., files enabling presentation of active font styles), inactive presentation options 148 (e.g., files enabling presentation of inactive font styles), and network interface 149. Repository 180 stores different presentation style options (e.g., files 181 or functional code enabling presentation of different respective font styles). Display screen 130 supports presentation of display region 112 (e.g., a selectable icon or toggle button), content 114 (e.g., text strings, images, etc.), and listing 120 (e.g., a dialog box, pop-up window, etc.). Listing 120 displays different presentation options 122 (e.g., presentation option 122-1, presentation option 122-2, . . . , presentation option 122-N), status information 124 (e.g., status information 124-1, status information 124-2, . . . , status information 124-N), and sample views 126 (e.g., sample view 126-1, sample view 126-2, . . . , sample view 126-N). Computer user 108 can launch corresponding content editor application 140 to present graphical user interface 150 on display screen 130. The computer user 108 navigates about graphical user interface 150 and provides commands via prompt 116 (e.g., a user controlled arrow that enables application of commands and selection of items appearing in graphical user interface 150).

The graphical user interface 150 presented by content editor application 140 enables modification of content 114 displayed on display screen 130. For example, via prompt 116, a computer user 108 can initially select a portion of content 114 (e.g., text) for modification. Thereafter, the computer user 108 can click on display region 112 (e.g., a toggle button) to initiate display of a respective dialog box including listing 120. Clicking on display region 112 is basically a command input by computer user 108 to display a dialog box of listing 120 presenting different editing options (e.g., presentation options 122) for selectively applying to all or part of content 114.

In response to receiving the command to view different selectable presentation options (e.g., font styles), the content editor application 140 initiates display of dialog box and a listing 120 of the different selectable presentation options (e.g., different font types) including active presentation options and inactive presentation options. As discussed above, corresponding status information 124 associated with the presentation options 122 indicates whether the presentation option is activated or deactivated, as well as whether a corresponding presentation option 122 is available for retrieval over network 190 such as the Internet.

In the context of the present example, each row can in listing 120 include a display of a presentation option 122 as well as corresponding status information 124 and a sample view 126. The presentation option 122 can be an identifier (e.g., an associated font name) indicating a selectable font style. The status information 124 can indicate whether the font style is active, inactive, available on-line for purchase, etc. The sample view 126 can illustrate how selected content will appear based on application of the corresponding presentation option 122.

In one embodiment, active presentation options 122 in the listing 120 (as indicated by corresponding status information 124) represent fonts that are managed by the operating system 142. In other words, to learn of active fonts associated with computer system 110, the content editor application 140 can initiate communication with the font manager of the operating system 142 to learn of active font styles. Typically, active font styles are loaded into memory for use by the content editor application 140 as well as other editor applications launched by operating system 142.

Inactive presentation options 122 in the listing 120 (as indicated by corresponding status information 124) represent fonts that are not directly managed by the operating system 142. The content editor application 140 or a font management function separate from the operating system 142 can optionally be configured to manage or know the existence of the inactive fonts and where they are stored, which can be either locally in computer system 110 or over a network 190.

Based on selection (e.g., clicking on) a presentation option (e.g., a particular font type) in the listing 120, the content editor application 140 applies a respective selected presentation option (e.g., selected font type) to modify the content 114 on the display screen 130.

Embodiments herein contrast with conventional applications. For example, the listing 120 produced by the content editor application 140 enables selection and application of different types of presentation options such as active, inactive, and on-line available types of fonts (e.g., presentation options) for applying to selected content 114. Providing different types of available fonts in a single selectable display region such as listing 120 eliminates the need for the computer user to leave a current editor application, launch a third party management tool to activate or retrieve on-line presentation options, and thereafter return to the current editor application 140 to manually apply a selected font to the content 114 (or portion thereof) being modified.

Further embodiments herein enable a respective computer user 108 to select a currently inactive font from the listing 120 for application to content 114 being edited. Upon selection of an inactive entry in the listing 120, the content editor application 140 can initiate functions such automatic registration of the selected inactive presentation option with operating system 142 to activate the selected inactive presentation option as well as modification of the content 114 according to the selected inactive presentation option. Accordingly, based on a single input command from a computer user 108, an inactive presentation option can be automatically activated (e.g., registered with the operating system) and applied to content 114. Once activated, the selected presentation option can be used by any editor applications launched by the operating system 142.

As mentioned above, the listing 120 can include status information 124 (e.g., a visual indication) enabling the computer user 108 to distinguish between different classes of presentation options such as active fonts, inactive fonts, fonts available on-line from a first server, fonts available on-line from a second server, purchasable fonts, etc.).

In addition to displaying the different presentation options 122 and their respective statuses via status information 124, the listing 120 can enable a corresponding computer user 108 to change a status associated with each of the different presentation options via application of commands to entries in the listing 120. For example, the content editor application 140 according to embodiments herein can enable the computer user 108 to provide input with respect to each of the entries in the listing 120 to selectively register (e.g., activate) inactive fonts and selectively de-register (or inactivate) currently active fonts. Accordingly, the computer user 108 can initiate management of different presentation options 122 (e.g., fonts) via functions provided by the content editor application 140 as opposed to a separate font management application running on the operating system 142.

In addition to (or in lieu of) obtaining locally available presentation options such as active presentation options 146 and inactivated presentation options 148, the content editor application 140 can be configured to communicate with remote server 170 (as well as other servers) to view different on-line available fonts in listing 120. For example, in response to receiving a command from a computer user 108 requesting to view on-line available presentation options, the content editor application 140 can initiate communication with the remote server 170 to learn of on-line available files 181 that support the different font options. Thus, server 170 can maintain a library of fonts accessible by computer user 108.

For each of the on-line available presentation style options (e.g., fonts) presented in the listing 120, prior to actual purchase and/or downloading, the content editor application 140 can provide a corresponding sample view 126 in the listing 120 to indicate how the selected content would appear on display screen 130 if a corresponding selectable presentation style option in the listing 120 were applied to the content 114. Thus, a computer user 108 can view how a corresponding on-line available font will appear in a composition (e.g., a document being created via use of content editor application 140) at the computer user 108 site prior to actual purchase or downloading of the corresponding presentation option file 181 in repository 180.

If desired, the computer user 108 can initiate purchase and downloading of one or more on-line available fonts (e.g., one of files 181 stored in repository 180) by providing appropriate input to graphical user interface 150 such as clicking on respective entries in listing 120. In other words, in response to receiving a command such as a user clicking on an on-line available presentation option entry in listing 120, the content editor application 140 can initiate communications over network 190 with server 170 to purchase/download a corresponding presentation option directly using graphical user interface 150.

Accordingly, the embodiments as described herein enable a respective computer user 108 to easily access and manage fonts via novel functionality provided in the context of a content editor application 140, eliminating or reducing disruptions in a content creation workflow process.

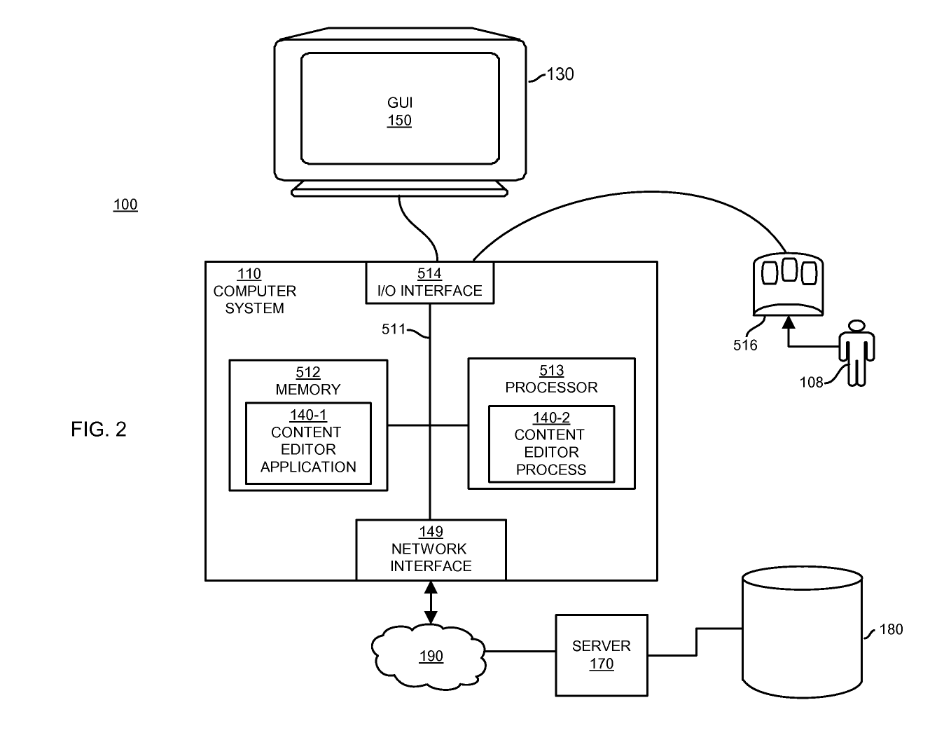

FIG. 2 is a block diagram of a computer environment 100 illustrating an example architecture of a respective computer system 110 for implementing content editor application 140 and related functionality according to embodiments herein. Computer system 110 can be a computerized device such as a personal computer, workstation, portable computing device, console, network terminal, processing device, etc.

As shown, computer system 110 of the present example includes an interconnect 511 that couples a memory system 512, a processor 513 (e.g., one or more processors), I/O interface 514, and a network interface 149. I/O interface 514 provides connectivity to peripheral devices 516 such as a keyboard, a mouse for controlling movement of prompt 116 on display screen 130, etc. User 108 provides input to computer system 110. Network interface 149 enables computer system 110 to communicate over network 190 to retrieve and transmit information (e.g., font files) from remotely located sources such as those stored in repository 180.

As shown, memory system 512 is encoded with content editor application 140-1 that supports management of fonts as well as other functionality as discussed above and as discussed further below. Content editor application 140-1 can be embodied as software code such as data and/or logic instructions (e.g., code stored in the memory or on another computer readable medium such as a disk) that supports processing functionality according to different embodiments described herein.

During operation according to one embodiment, processor 513 accesses memory system 512 via the use of interconnect 511 in order to launch, run, execute, interpret or otherwise perform the logic instructions of the content editor application 140-1. Execution of the content editor application 140-1 produces processing functionality in content editor process 140-2. In other words, the content editor process 140-2 represents one or more portions of the editor application 140-1 performing within or upon the processor 513 in the computer system 110.

It should be noted that, in addition to the content editor process 140-2 that carries out method operations as discussed herein, other embodiments herein include the editor application 140-1 itself (i.e., the un-executed or non-performing logic instructions and/or data). The content editor application 140-1 may be stored on a computer readable medium such as a floppy disk, hard disk or in an optical medium. According to other embodiments, the editor application 140-1 can also be stored in a memory type system such as in firmware, read only memory (ROM), or, as in this example, as executable code within the memory system 512 (e.g., within Random Access Memory or RAM).

In addition to these embodiments, it should also be noted that other embodiments herein include the execution of content editor application 140-1 in processor 513 as the content editor process 140-2. Thus, those skilled in the art will understand that the computer system 110 can include other processes and/or software and hardware components, such as an operating system that controls allocation and use of hardware resources.

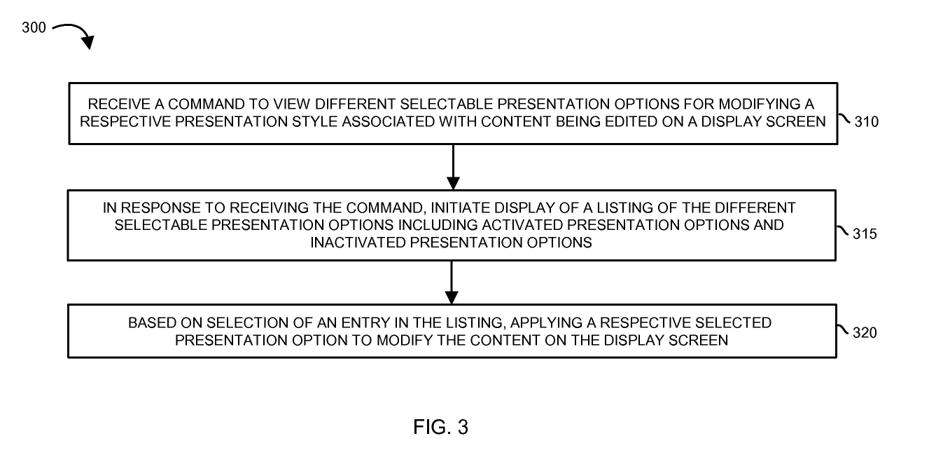

Functionality supported by computer system 110 and, more particularly, functionality associated with editor application 140-1 and editor process 140-2 will now be discussed via flowcharts in FIGS. 3 through 7. For purposes of the following discussion, computer system 110 or (e.g., content editor application 140-1 and/or content editor process 140-2) generally performs steps in the flowcharts.

Note that there will be some overlap with respect to concepts discussed above for FIGS. 1 and 2. Also, note that the steps in the below flowcharts need not always be executed in the order shown.

Now, more particularly, FIG. 3 is a flowchart 300 illustrating a technique of previewing different types of presentation options according to an embodiment herein. Flowchart 300 of FIG. 3 will make reference to matter previously discussed above.

In step 310, the content creation application 140 receives a command (e.g., generated by selection of display region 112 with prompt 116 in FIG. 1) from a source such as user 108 to view different selectable presentation options (e.g., font options). The different presentation options can be selected by the user 108 for modifying a respective presentation style associated with content 114 (or portion thereof) being edited on a display screen 130.

In step 315, in response to receiving the command, the content creation application 140 initiates display of a listing 120. The listing 120 includes entries for each of the different selectable presentation options including activated presentation options (e.g., active fonts) and inactivated presentation options (e.g., inactive fonts).

In step 320, based on selection of an entry (e.g., a particular presentation option 122) in the listing 120, the content creation application 140 applies the respective selected presentation option 122 to the content 114 on the display screen 130.

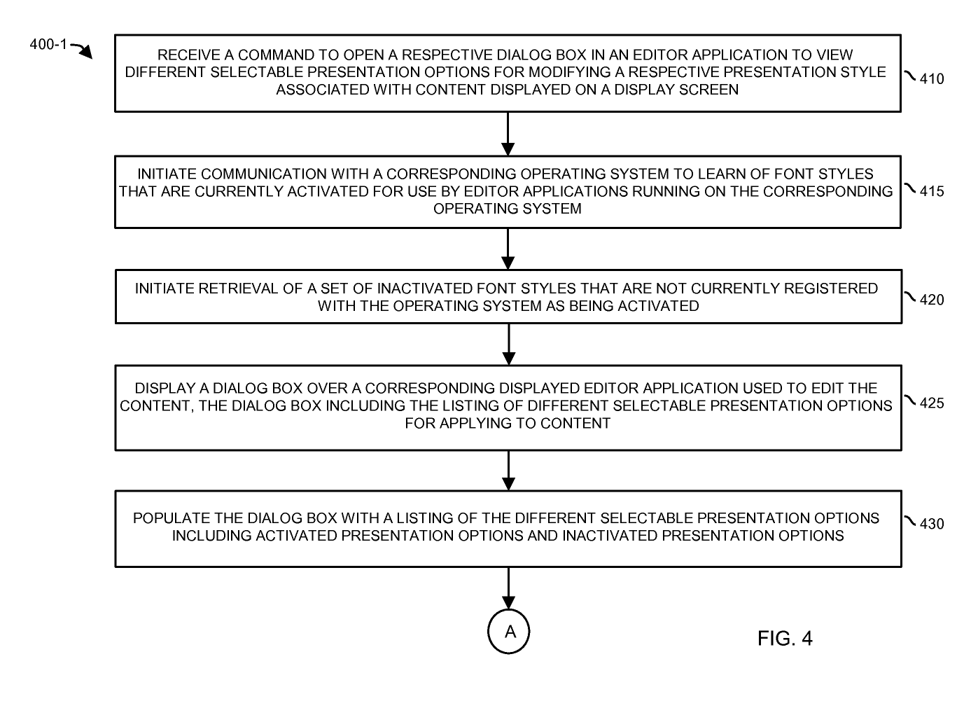

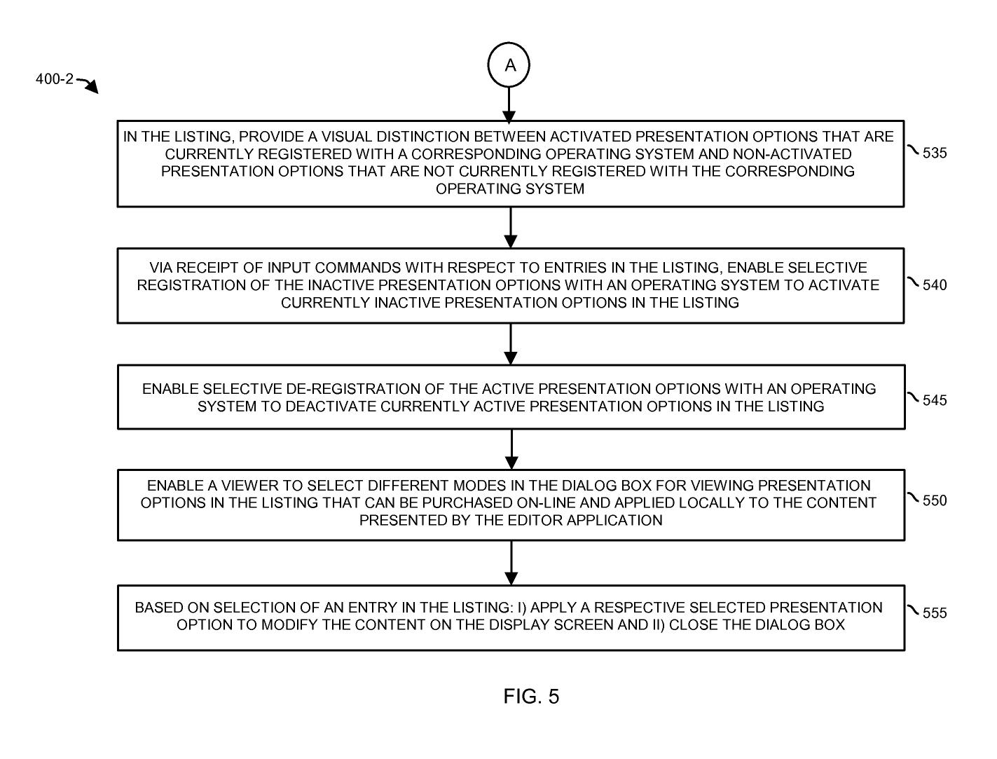

FIGS. 4 and 5 combine to form flowchart 400 (e.g., flowchart 400-1 and flowchart 400-2) illustrating more specific techniques associated with embodiments herein. Note that according to the present example embodiment, the steps in flowcharts 400-1 and flowchart 400-2 (collectively, flowchart 400) are carried out by a processing entity such as content editor application 140. However, note that the type of entity that executes these operational steps can vary depending on the application.

In step 410 of FIG. 4, the content editor application 105 receives a command (e.g., based on selection of display region 112) to open a respective dialog box (e.g., listing 120) in graphical user interface 150 (e.g., an editor application) to view different selectable presentation options 122 for modifying a respective presentation style associated with content 114 displayed on display screen 130.

In step 415, the content editor application 140 initiates communication with a corresponding operating system 142 to learn of different font styles that are currently activated for use by editor applications running on the corresponding operating system 142.

In step 420, the content editor application 140 initiates retrieval of a set of inactivated font styles that are not currently registered with the operating system 142 as being activated.

In step 425, the content editor application 140 displays a dialog box over a corresponding displayed graphical user interface 150 used to edit the content 114. The dialog box includes the listing 120 of different selectable presentation options for applying to content. The dialog box can be configured as a special window that pops for display to user 108 in response to clicking on display region 112.

In step 430, the content editor application 140 populates the dialog box with a listing 120 of the different selectable presentation options 122 including activated presentation options and inactivated presentation options. Thus, the different presentation options in listing 120 can be displayed along with status information 124 indicating font type (e.g., active fonts, inactive fonts, on-line available fonts, purchasable fonts, etc.)

In step 535 of FIG. 5, the content editor application 140 provides a visual distinction in the listing 120 to distinguish between activated presentation options (e.g., active fonts) that are currently registered with a corresponding operating system 142 and non-activated presentation options (e.g., inactivated fonts) that are not currently registered with the corresponding operating system 142.

In step 540, via receipt of input commands with respect to entries (e.g., listed presentation options 122) in the listing 120, the content editor application 140 enables selective registration of inactive presentation options with an operating system to activate any currently inactive presentation options in the listing 120. In other words, a computer user 108 can click on an inactive presentation option and apply an appropriate command to perform underlying operations that convert the inactive presentation option to an active presentation option registered with the operating system 142.

As indicated in step 545, the content editor application 140 enables selective de-registration of the active presentation options with operating system 142. For example, a computer user 108 can click on an active presentation option and apply an appropriate command to perform underlying operations that convert the active presentation option to an inactive presentation option that is no longer registered with the operating system 142.

In step 550, the content editor application 140 enables a viewer (e.g., computer user 108) to select different modes (e.g., an on-line mode) in which the listing 120 includes presentation style options that can be purchased on-line and applied locally to the content presented on display screen 130.

In step 555, according to one embodiment, based on selection of an entry in the listing 120, the content editor application 140 applies a respective selected presentation option to modify the content on the display screen 130 and, thereafter initiates closing of the dialog box.

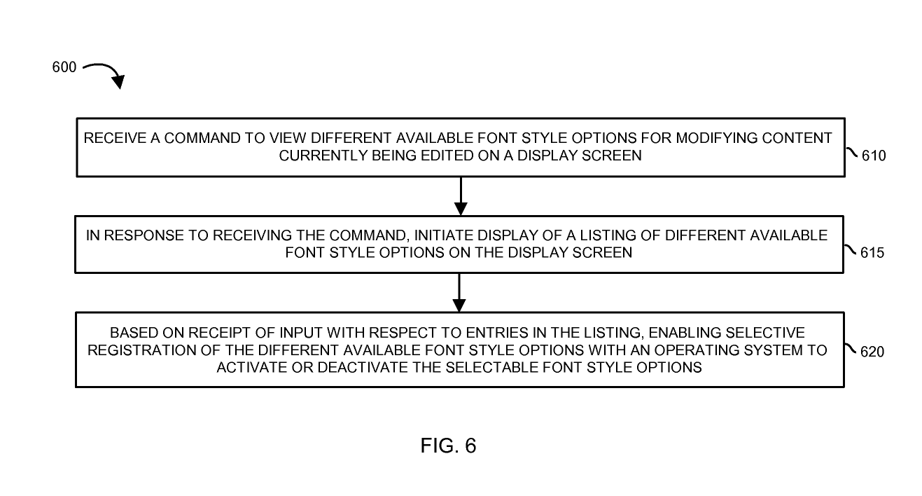

FIG. 6 is a flowchart 600 illustrating a technique of enabling selective registration of presentation options according to embodiments herein. Note that flowchart 600 of FIG. 6 will make reference to matter previously discussed above.

In step 610, the content editor application 140 receives a command to view different available font style options for modifying content 114 currently being edited on a display screen 130.

In step 615, in response to receiving the command, the content editor application 140 initiates display of a listing 120 of different available font style options on the display screen 130.

In step 620, based on receipt of input from user 108 with respect to entries in the listing 120, the content editor application 140 enables selective registration of the different available font style options with an operating system 142 to activate or deactivate the selectable font style options. In other words, a user 108 can select a presentation style options in listing 120 and apply an activate or deactivate type of command to selectively manage fonts within the context of a graphical user interface 150 provided by content editor application 140.

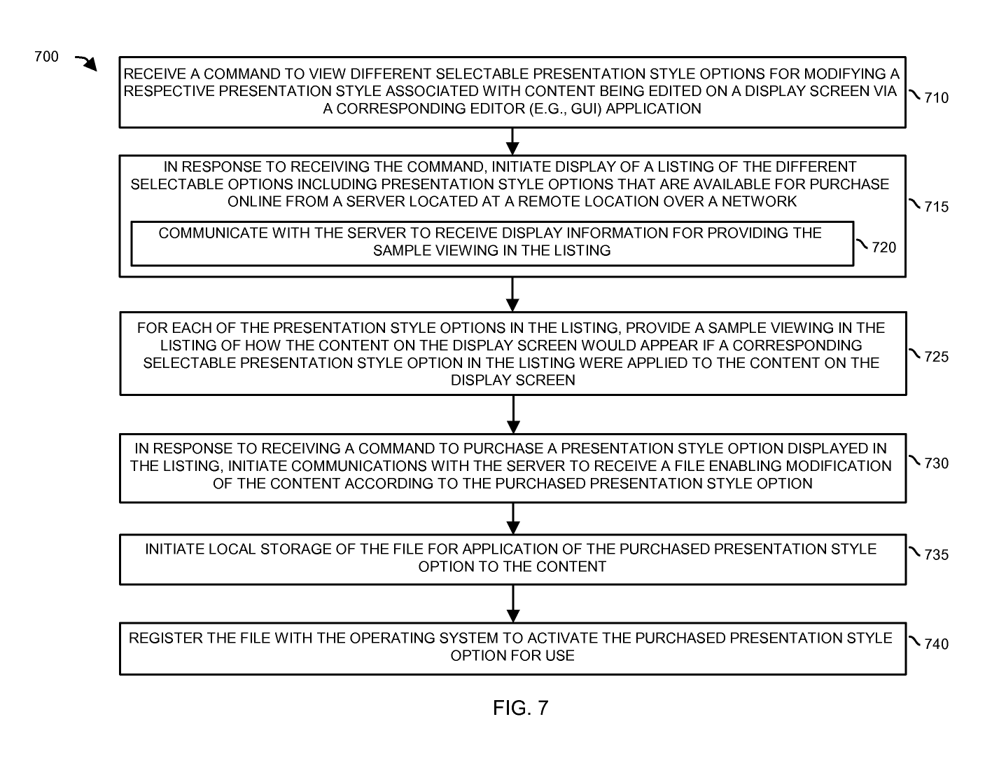

FIG. 7 is a flowchart 700 illustrating additional functionality supported by content editor application 140 according to embodiments herein. Note that flowchart 700 of FIG. 7 will make reference to matter previously discussed above.

In step 710, the content editor application 140 receives a command from computer user 108 to view different selectable presentation style options. The different presentation style options, when selected, enable modification of a respective presentation style associated with content 114 being edited on display screen 130.

In step 715, in response to receiving the command from computer user 108, the content editor application 140 initiates display of a listing of the different selectable options including presentation style options that are available for purchase online from a server 170 located at a remote location over a network 190.

In sub-step 720 associated with step 715, the content editor application 140 communicates with the server 170 to receive display information for providing the sample viewing 126 (e.g., preview) in the listing 120. To display the sample, the content editor application 140 can send the text string to the remote server 170 for creating an image with the appropriate font style for displaying in listing 120 or the content editor application can receive a font file enabling the computer environment 140 locally modify the text string in accordance with a given on-line font.

In step 725, for each of the presentation style options 122 in the listing 120, the content editor application 140 provides a sample viewing 126 in the listing 120 of how selected portions of the content 114 on the display screen 130 would appear if a corresponding selectable presentation style option 122 in the listing 120 were applied to the selected portions of content 114.

In step 730, in response to receiving a command to purchase a presentation style option 122 displayed in the listing 120, the content editor application 140 initiates communications with the server 170 to receive one or more presentation option files (e.g., a font file) enabling modification of the selected portion of the content 114 according to the purchased presentation style option.

In step 735, the content editor application 140 initiates local storage of the retrieved file for local application of the purchased presentation style option to the content 114 on display screen 130.

In step 740, the content editor application 140 initiates storage of the font file locally in a sub-directory accessible by computer system 110. Additionally, the content editor application initiates registering the newly obtained file with the operating system 142 to activate the purchased presentation style option for use. As previously discussed, the operating system 142 manages the set of active or registered fonts. After registration, each editor application launched by the operating system 142 can communicate with the operating system 142 to ascertain which font types are currently active.

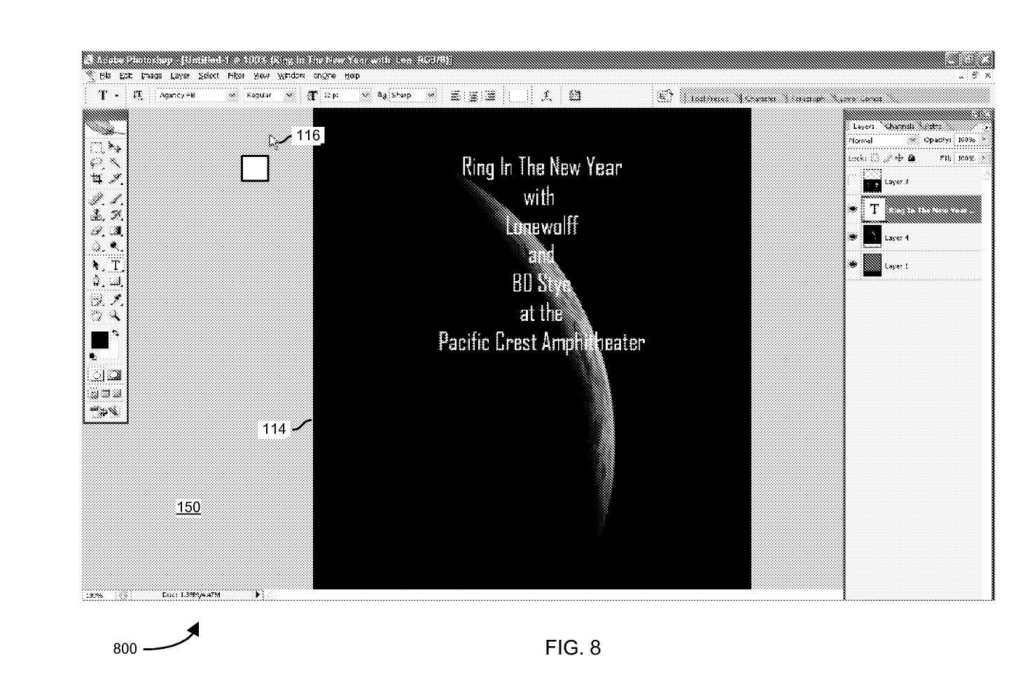

FIG. 8 is a screenshot 800 illustrating an example of graphical user interface 150 supported by content editor application 140 according to embodiments herein. As shown, a respective computer user 108 uses mouse-controlled prompt 116 to select and apply different editing functions to content 114.

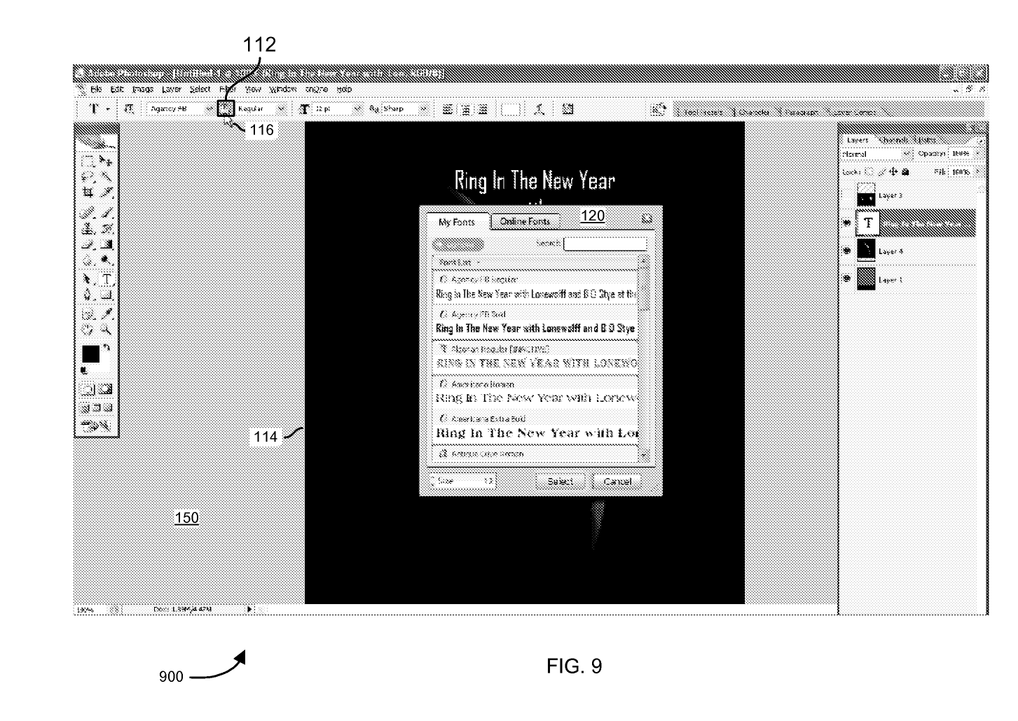

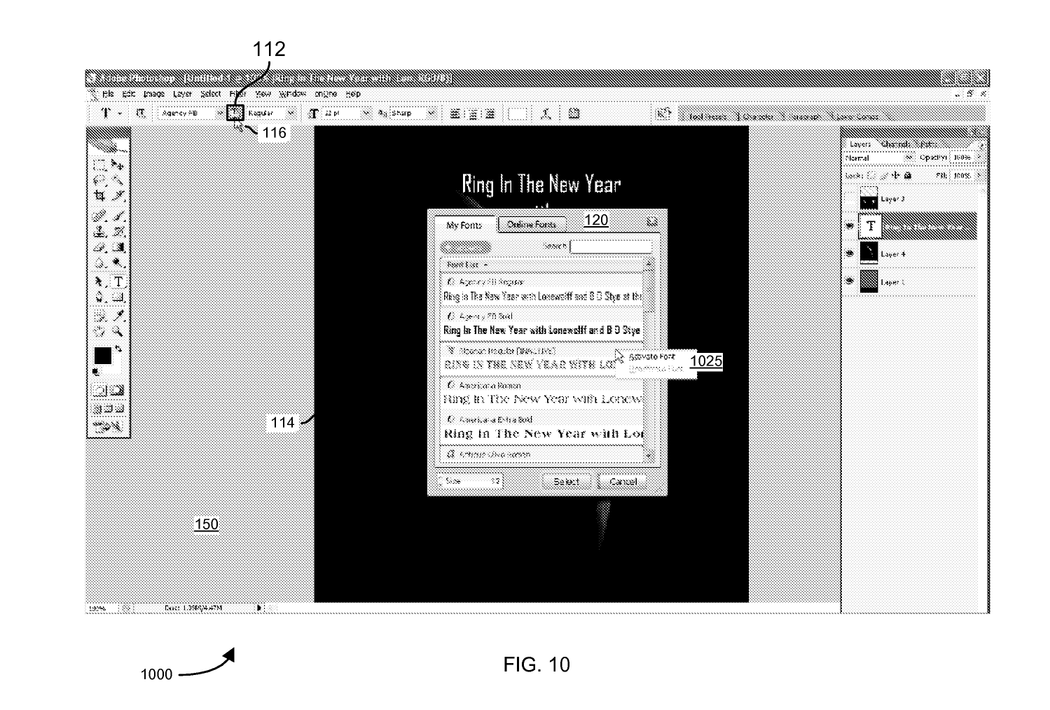

FIG. 9 is a screenshot 900 illustrating an example of graphical user interface 150 supported by content editor application 140 according to embodiments herein. As shown, a respective computer user 108 uses mouse-controlled prompt 116 to select (e.g., click on) a corresponding toggle button in display region 112. In response to selecting display region 112, content editor application 140 initiates display of listing 120 in graphical user interface 150.

Listing 120 displays entries for each of multiple font styles. For example, the second row entry in listing 120 displays a presentation option 122 of “Agency FB Bold” and a corresponding sample view 126 associated with selected text “Ring In The New Year with Lonewolff and BD Stye at the Pacific Coast Amphitheater.” In the context of the present example, lack of status information 124 (next to the font name) indicates that the font style is an active presentation option 146 registered with the operating system 142. Note that the listing 120 can be modified to include appropriate status information 124 (e.g., the word “active”) indicating that the font style is currently active. Lack of any status information in this example indicates to the computer user 108 that the font is currently activated.

The third row entry of listing 120 includes a presentation option 122 of “Algerian Regular,” status information 124 (e.g., the word “inactive” to indicate that the presentation option 122 is currently inactivated), and a corresponding sample view 126 (e.g., selected text “Ring In The New Year with Lonewolff and BD Stye at the Pacific Coast Amphitheater”). Accordingly, a computer user 108 can easily identify that the font style (e.g., Algerian Regular) is inactive and how the selected text (e.g., the sample view of “Ring In The New Year with . . . ”) would appear in such a font style.

To apply a selected font to the content 114, the user can click on the “select” button displayed in listing 120.

Upon selection such as right clicking a respective mouse while prompt 116 is in a vicinity of the third row entry of listing (e.g., the inactive font), the content editor application 140 can initiate display of a pop-up window 1025 enabling a respective user to change the status associated with the selected one of multiple entries. For example, the pop-up window 1025 can include options for selection by user to activate a corresponding font style in listing 120 if it is currently deactivated and deactivate a corresponding font style if it is currently activated. Other methods can be employed to enable the computer user 108 to change a status of the different font styles presented in listing 120 as well. Thus, embodiments herein are not restricted to use of a pop-up window 1025.

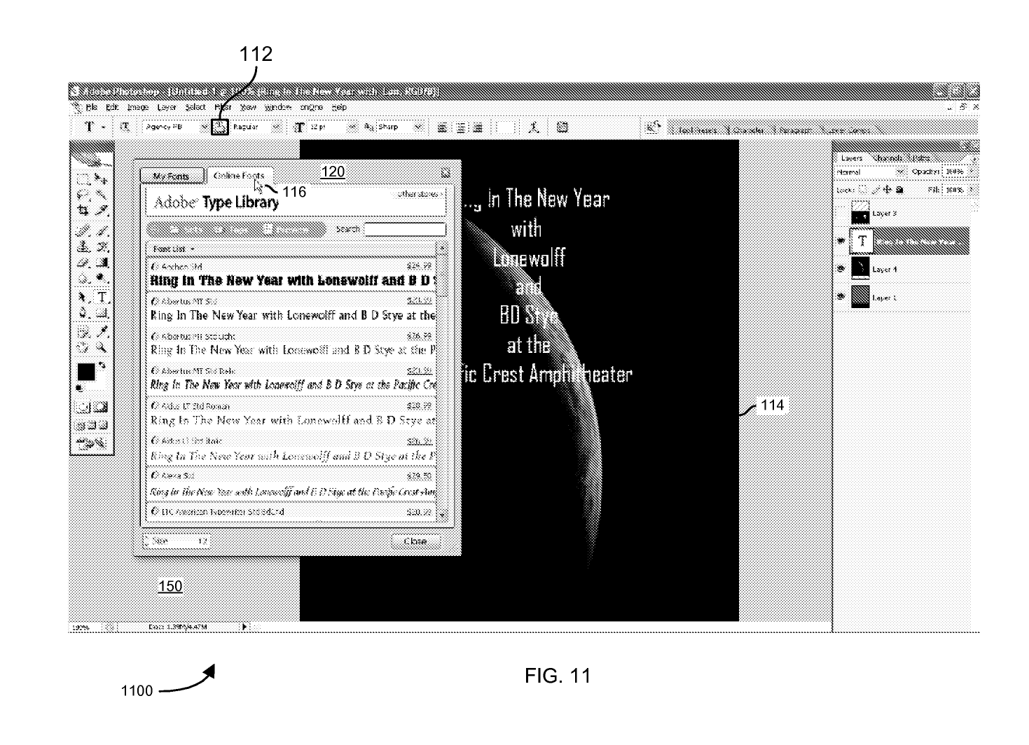

FIG. 11 is a screenshot 1100 illustrating an example of graphical user interface 150 supported by content editor application 140 according to embodiments herein. As shown, a respective computer user 108 uses mouse-controlled prompt 116 to select (e.g., click on) the “Online Fonts” option to view different types of font styles available on-line as opposed to the “My Options” discussed in connection with screenshot 1000 above that shows locally available fonts. As previously discussed, the content editor application 140 initiates display of listing 120 in graphical user interface 150 in response to the computer user 108 selecting display region 112 with prompt 116.

Each entry (e.g., row) of listing 120 displayed in screenshot 1100 indicates a corresponding presentation option 122 (e.g., Aachen Std, Albertus Std, . . . ), status information 124 (e.g., a respective price such as $24.99, $23.99, etc. for purchasing the font style), and a sample view 126 illustrating how the selected content will appear when applied to the selected content.

Note that the content editor application 140 can be configured to receive input with respect to a given entry in listing 120. For example, a respective computer user 108 can click on the different prices (or other chosen element) to initiate purchase of the on-line available font.

As previously discussed, in response to receiving such a command (e.g., a single click of the price or font style indicator), the content editor application 140 can initiate payment for the selected font, retrieval of the selected font or font file from remote server 170, and local application of the newly purchased font to the selected content 114 via an on-line transaction. At some tme relative to the transaction, the content editor application 140 can initiate closing of the dialog box displaying listing 120 as well as registering the newly purchased font with the operating system 142 for future use. Accordingly, the newly purchased font is available by looking the “My Fonts” folder displayed in listing 120.

Note that techniques herein are well suited for use in content editor applications such as those that support creating, modifying, managing, and/or displaying of content. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
receiving, by an editing application configured to generate a document including textual content in response to textual editing, a command to view different fonts to apply to text being edited on a display screen;
in response to receiving the command:
communicating with a remote server to identify at least one font available at the server, and
generating a graphical interface within the editing application, the graphical interface comprising of a listing of the fonts, the listing comprising the identified at least one font available at the server;
using data provided by the server, providing a preview of text formatted according to the identified at least one font available at the server;
based on receiving selection of a font from the listing, applying the selected font to the textual message on the display screen; and
purchasing the at least one font available at the server in response to a purchase input received via the graphical interface and selecting the at least one font for purchase.

2. (canceled)

3. A method as in claim 1, wherein the listing comprises an inactivated font not registered with an operating system and wherein the method further comprises,
enabling selective registration of the inactivated font with the operating system from within the listing in response to a registration input command received via the graphical interface.

4. (canceled)

5. A method as in claim 1 further comprising:
enabling selective de-registration of an active font with an operating system from within the listing, wherein the selective de-registration occurs in response to a de-registration input received via the graphical interface within the editing application.

6. A method as in claim 1:
wherein the listing further provides a visual distinction between activated fonts currently registered with an operating system and inactivated fonts not currently registered with the operating system.

7-17. (canceled)

18. A method comprising:
receiving a command to view different selectable presentation style options for modifying a respective presentation style associated with content being edited on a display screen by an editor application, the editor application configured to generate a textual document;
in response to receiving the command, generating a graphical interface within the editor application, the graphical interface comprising a listing of the different selectable options, the different selectable options including presentation style options that are available online from a server located at a remote location over a network;
for each of the presentation style options in the listing, providing a sample viewing in the listing of how the content on the display screen would appear if a corresponding selectable presentation style option in the listing were applied to the content on the display screen; and
purchasing at least one presentation style option available at the server in response to a purchase input received via the graphical interface and selecting the at least presentation style option for purchase.

19. A method as in claim 18, wherein initiating the display of the listing includes:
communicating with the server to receive display information for providing the sample viewing in the listing.

20. A method as in claim 18, wherein purchasing the at least one presentation style option comprises:
initiating communications with the server to receive a file enabling modification of the content according to the purchased presentation style option;
initiating local storage of the file for application of the purchased presentation style option to the content; and
registering the file with the operating system to activate the purchased presentation style option for use.

21. A computer program product including a non-transitory computer readable storage medium having instructions stored thereon for processing data information, such that the instructions, when carried out by a processing device, enable the processing device to perform the operations of:
receiving a command to view different available font style options for modifying content currently being edited on a display screen in a text editing application, the text editing application configured to generate a document including the content;
in response to receiving the command, generating a graphical interface within the text editing application, the graphical interface comprising a listing of different available font style options on the display screen, the listing including at least one font style option available from a remote server;
displaying a preview of text formatted using the at least one font style option available from the remote server, the preview displayed using data provided by the remote server;
purchasing the at least one font style option available from the remote server in response to a purchase input received via the graphical interface and selecting the at least one font for purchase; and
based on receipt of input with respect to entries in the listing, enabling selective registration of the different available font style options with an operating system to activate or deactivate the selectable font style options, wherein the selective registration occurs in response to a registration input received via the graphical interface within the text editing application.

22. A computer program product as in claim 21 further supporting operations of:
based on a received selection of an entry in the listing, applying a respective selected presentation style option associated with the received selection to modify the content on the display screen.

23. A computer program product as in claim 21, wherein enabling selective registration includes:
for a given font style option presented in the listing, providing an indication that the given font style option is currently registered with the operating system as an activated font style; and
in response to receiving a command to deactivate the given font style option, initiating deregistration of the given font style option with the operating system.

24. A computer program product as in claim 21 further supporting operations of:
based on selection of a given font style option from the listing for application to the content on the display screen:
identifying that the given font style option is currently deactivated in which the given font style option is not registered-as being active with a corresponding operating system;
initiating activation of the given font style option by registering the given font style option with the operating system; and
initiating application of the given font style option to the content on the display screen being displayed by a corresponding content editor application.

25. A computer program product as in claim 21, wherein initiating display of the listing of the different selectable font style options on the display screen includes:
initiating communication with a corresponding operating system to learn of locally stored fonts that are currently activated for use by editor applications running on the corresponding operating system; and
initiating retrieval of a set of inactivated fonts that are not registered with the operating system as being active fonts.

26. A computer program product as in claim 23 further supporting operations:
for a given inactive presentation option displayed in the listing, providing a sample of how the content would be displayed on the display screen if the given inactive presentation option is selected by a user for application to the content.

27. A computer system comprising:
a processor;
a memory unit that stores instructions associated with an application executed by the processor; and
an interconnect coupling the processor and the memory unit, enabling the computer system to execute the application and perform operations of:
providing a text editing interface;
generating a document based on input received via the text editing interface;
receiving, from within the text editing interface, a command to view a font style option for modifying content, the font style option available from a remote server;
in response to receiving the command, generating a graphical interface within the text editing interface, the graphical interface comprising a listing of the available font style option on the display screen;
receiving to the graphical interface input selecting an font style option from the listing; and
in response to the input selecting the font style option, providing a command to the remote server to generate a preview showing text that has the selected font style option applied thereto;
causing the computer system to display the preview, and
purchasing the font style option available from the remote server in response to a purchase input received via the graphical interface and selecting the at least one font for purchase.

28-31. (canceled)

32. A computer-implemented method, comprising:
providing a text editing interface in a text editing application executed by a computing device, the text editing application configured to generate a document comprising textual content;
providing a font selection interface within the text editing application;
receiving input selecting a font in the font selection interface;
in response to the input selecting the font, providing, by the text editing application, a command to a remote server to generate a preview of text having the selected font applied thereto; and
purchasing the selected font in response to a purchase input received via the font selection interface and selecting the selected font for purchase.

33. The computer-implemented method of claim 32, further comprising:
receiving input via the text editing interface, the input defining textual content,
wherein the command provided to the remote server comprises the textual content and the preview includes the textual content having the selected font applied thereto.

34. The computer-implemented method of claim 32, further comprising:
displaying the preview generated by the remote server.

35. The computer-implemented method of claim 34, further comprising:
receiving input via the text editing interface, the input defining textual content; and
generating a document comprising the textual content, the textual content having the selected font applied thereto.

36. The method of claim 1, further comprising receiving a single registration input command via the graphical interface and registering the inactivated font with the operating system without using an additional interface separate from the editing application.

37. The method of claim 18, wherein the purchase input comprises a single input command.

38. The method of claim 20, wherein the purchase input comprises a single input command and wherein initiating communications with the server, initiating local storage of the file, and registering the file are performed without additional input to the graphical interface.
